(19) United States
(12) Patent Application Publication
(10) Pub. No.: US 2014/0289057 A1
(43) Pub. Date: Sep. 25, 2014

(54) System and Method for Talent Promotion

(71) Applicants: Christopher Stanley Kowal, Brighton, MI (US); Frederick William Mau, II, Royal Oak, MI (US)

(72) Inventors: Christopher Stanley Kowal, Brighton, MI (US); Frederick William Mau, II, Royal Oak, MI (US)

(21) Appl. No.: 13/849,132

(22) Filed: Mar. 22, 2013

(51) Int. Cl. G06Q 30/02; G06Q 50/00

(52) U.S. Cl. CPC G06Q 30/0277; G06Q 50/01
USPC 705/14.73

(57) ABSTRACT

A system and method for talent promotion including a social network, a venue and a brand accelerator. Users of the system may include artists, managers, venues and fans. The users of the system are allowed to interact with other users within the system to promote their brand as it relates to content and talents. The social network component provides the platform for the interaction between users. Each user may also maintain a homepage which allows for the uploading of content and interaction with various users. The brand accelerator utilizes data within and outside of the system to assist the users with promotion of their brand.

### CROSS REFERENCE TO RELATED APPLICATIONS

The present application is entitled to the benefit of the earlier filing date and priority of, co-pending U.S. Provisional Application Ser. No. 60/614,464 entitled “SYSTEM AND METHOD FOR TALENT PROMOTION,” filed Mar. 22, 2012, the disclosure of which is hereby incorporated by reference.

### FIELD OF THE INVENTION

The present invention generally relates to software applications. More particularly, the present invention relates to a software application and platform for talent promotion utilizing social media resources.

### BACKGROUND

An important aspect for most artists in the entertainment industry is their ability to promote themselves to create a following or fan base. Based on the goals and aspirations of the artists they may seek to promote themselves on a local, regional or global scale. To these ends, various tools may be utilized by artists to reach and create a fan base. Traditional forms of promotions such as publications, handouts, newspapers advertisements and columns, and signage may be used to reach and create a local fan base. Television, radio, and the internet may be utilized to reach and create a regional or global fan base. While all of the aforementioned forms of promotion allow artists to advertise themselves, only few of these forms of promotion allow interaction with a fan base while providing some feedback to the artist for improvement.

One of the most well-known forms of development and promotion for artists over the past decade is television. Many television shows have developed over this time period whereby artists are promoted, provided feedback and coaching, and allowed to interact with their fan base. Some of the more popular television shows are American Idol and The Voice. Many other television shows have also been created based on the same premise. While a popular form of promotion, only a limited number of artists ever receive an opportunity to appear or compete on these shows. As such, access by artists to the shows is very limited to only a select number of applicants.

Online applications have become increasingly popular among artists due to the ability of artists, no matter how big or small, to reach large groups of potential fans online. A very well-known web application utilized by many artists is YouTube. YouTube allows artists to post content online which may be viewed and shared by viewers. This allows an artist to share content on a wide scale with the potential to go viral thus resulting in a quickly grown fan base. Many sites similar to YouTube also allow users to rate content and provide comments that may be viewed by the online community. Many other websites have similar functionalities allowing users to post content and interact with their fan base. While these tools allow users to promote themselves and receive feedback, there is little opportunity for artists to receive coaching or feedback on how to better promote content and develop their brand.

As described, many tools exist which allow artists to promote themselves locally, regionally, and globally. There are also various types of promotion available which allow artists to receive feedback and coaching to help them promote themselves and develop their brand. In view of the promotional tools available to artists, there is a need for a tool which allows all artists, both big and small, an opportunity to reach fans on a local, regional, and global level while receiving the necessary feedback, coaching and access to resources thereby allowing them to promote themselves to the best of their ability.

### SUMMARY OF THE INVENTION

A system for promoting talents of a user comprising a social network allowing the user to interact with a community of users within the system, a venue comprising a homepage whereby the venue allows the user to upload content and information to the homepage for review and download by the community of users within the system, and a brand accelerator whereby the brand accelerator provides the user with a set of one or more next best actions for promoting the user within the system. The set of next best actions may be based on information received by the brand accelerator from the social network.

The social network may populate one or more social networks external to said system with a feed of content provided by the user. The brand accelerator may utilize information from the social network and/or a media stack to provide the set of next best actions to the user. The brand accelerator may also utilize information from a user stack to provide next best actions to the user. The brand accelerator may include a functionality which provides one or more outputs to a set of one or more influencers to promote the user.

The brand accelerator may receive one or more values from a data analyzer to generate a set of next best actions to be provided to the user. The data analyzer may generate one or more values selected from a media influence value, a virality value, a market cap value and a new releases value. The brand accelerator generates the set of next best actions based on calculations with respect to one or more of a marketability value, a connections value and an offers and incentives value. The marketability value, the connections value and the offers and incentives value the calculated by said brand accelerator. The connections value, the offer and incentives value and the set of next best actions may be communicated to the user via a ranking, a scorecard, or a graphical representation.

The system may include a gameplay feature, whereby the gameplay feature includes a plurality of levels attainable by the users, each of the plurality of levels requiring completion of a set of criteria by the user. Each of the levels obtained by the user may provide different opportunities for the user. A set of service providers may also be provided to users as a resource within the system.

The system may include a search functionality whereby users of the system may search for other users based on a series of search criteria. The system may also include customization portal which provides for customization of the venue by said user. The customization portal may include a sponsorship category which allows users to apply for sponsorships within the system.

The platform components of the system may include a database, user interfaces, technology and tools. Examples of the databases may be based on user, influencers, fans, labels, venues, offers, incentives, next best actions, game rules, resources, analytics and rankings. User interfaces may include user registration, user venue, social network, customization portal, services exchange, talent search and the stage functionality within the venue. Technology and tools may include mobile devices, infrastructure hosting, video hosting, runtime data processing, batch data processing, analytics tools, data exchange APIs, partner hub, web crawlers, game and badge engine, content delivery network, and virtual currency.

The application components of the system may include modules and components. The modules may include the dream path module, the brand accelerator, the data analyzer, the game engine, the search functionality, the venue stage and the venue store. The components may include a talent profile, a dream path, a storage locker, star links, ad services, license controls, participation policies, communities, content/content stack, media stack, user stack, support stack, label stack, scorecards, registration, in-app billing, e-marketing, e-commerce, venue, virtual goods and contests.

### DETAILED DESCRIPTION OF THE PREFERRED EMBODIMENTS OF THE INVENTION

Described herein is a software application and platform which allows artists to promote their talents utilizing social media resources. Such talents may include musical talents (singing/playing musical instruments), dancing, choreography, acting, comedy, magic, and any other talents focused on the entertainment industry. The software application may be supported by computers and mobile media devices such as smartphones and tablets. The software application provides users with a simple and efficient way to share their performances on a global scale in relevant markets. Additionally, users may be provided with the opportunity to earn revenue related to the growth of their popularity.

Users of the software application may include artists, managers, venues, and fans. Artists will be able to use the software application to share their content and find opportunities to perform and promote their brand. Managers and venues may utilize the software application to search for new talents and promote themselves within the system. Fans may use to system to view, share and purchase content while following their favorite artists. All users in the system will have various channels to communicate with one another thereby reflecting a connected community.

The software application and platform may be differentiated from user to user by product and personal experience. For instance, users, such as artists, with different levels of experience will have different types of options available within the system. Artists may also provide different types of content which can provide further differentiation within the system. Essentially, each user can make the application and platform unique to themselves based on their goals within the system. The platform itself is designed to stimulate positive activity around the brands put forth by the users. The platform may automatically populate related social sites as appropriate, while continually reporting back to the users branding improvement trends with recommended courses of action. The software application may include learning functionality which collects data about the users as they progress within the application. During use of the application over time, the application aids in identifying patterns developing or existing in the user's talent category and also provides suggestions to promote the user's activity over time.

The software application may generally comprise a social network, a venue, a brand accelerator, and a customization portal. The social network may be a function within the overall system architecture. Additionally, the social network may work in conjunction with one more external social networks such as Facebook or Twitter. The social network function allows users to maintain a journal of their creations and performances within the system while providing control and management of their brand and experience in a secure and efficient way. For example, users may create various content which is saved and automatically compiled within the system in a manner dictated by the user. Users may provide or select rules by which the content is compiled and ultimately presented in the system. The data may be compiled into a journal whereby the data is arranged in a way to strengthen the brand of the user by promoting areas of strength and working to resolve areas of actual or perceived weakness.

The social network may also allow users to keep track of and communicate with their growing fan base with a single feed. The social network may further include functionality which learns about users and posts activity of the users during travel and performances and other brand building activities. For example, a user may quickly update or post to the social network with pictures, feeds, updates and other content on a real time basis. Comments from other users may also be included on a real time basis in response the social network posts and updates.

The learning functionality of the social network may learn about the user and the fan base of the user while auto-contextualizing fan base and artist engagement. As described herein, auto-contextualization is a rationalization and positioning of community behavior to support brand development and/or brand acceleration. For example, behavior metrics in the form of raw data will be supplied from the social network function to the brand accelerator for processing. The brand accelerator will ultimately process the behavior metrics to provide feedback or coaching to the users to improve their overall brand and image within the system. The analytics of the brand accelerator will be described in detail later. The behavior metrics may include one or more of content viewed, content purchased, content shared, type of comments, rate of comments, keywords, votes, site visits, rate of abandonment (fans abandoning the site), number of fans, and the rates of any aforementioned behavior metrics.

The social network tracks and reports on fan base, sponsor and advertiser activity to assist with brand improvement and revenue generation for users. For example, the social network may provide sponsor and advertising opportunities to potential sponsors and advertisers. Such opportunities may be accompanied with metrics showing the success rate of the advertising activity for the user providing the opportunity. Additionally, promotions may be provided to fans of a specific content area within the system.

The social network may also auto-stimulate community activity with the user's social network by providing automated posts, messaging and offers. Users may establish an auto messaging pattern with pre-stored messages that are geographically aligned such that the message will be sent out to a given community when a given geographical region reaches a predetermined time. For example, an artist may send a pre-stored message to their global community on a region by region basis once each region reaches a predetermined time. This may provide an opportunity for users to provide updates, offers, promotions and discounts to their fan community on a timely basis. The auto-stimulating functionality may also be based upon occurrence of a pre-determined condition. An example of a condition may be the occurrence of an activity exceeding the normally expected rate for that activity (e.g. views, visits, purchase, votes).

The social network may also include security controls allowing the user to set parameters that determine the range and scope of community interactivity and account visibility. This will allow the user to better control the way their brand is portrayed within the community. Such controls may allow users to restrict community influence with regard to the users brand. For example, an artist may require review and/or approval to allow another user to post content regarding the artist. Additionally, security measures may be implemented with respect to various types of content which restrict the ability of the community to take certain actions with respect to the content. For example, certain types of content may be prevented from being shared, commented on, downloaded, or viewed. Profile controls within the social network may allow the artist to create an open-market talent image (i.e. brand) and engage the social network as an accelerator and protector of that open-market talent brand.

The social network may also include a search function which allows users to search for content or other users within the system. Managers, venues and fans may utilize the search function to search for specific types or artists in certain types of genres. Artists may utilize the search function to search for managers, venues or fans within the system. Specifically, the search function may allow users to search for affinity groups within a given user category. The use of affinity group searching will provide users greater ability to direct specific content to a given group of users.

The social network may include in-application billing with a monetization converter and secure transaction processing capability. This will enable the purchase of credits redeemable to enhance various features and provide additional functionality and options within the social network for the users. This will allow the system to recognize virtual currency purchased or earned within the system, virtual currency earned or purchased outside the system, and well as actual currency from outside the system. This will also allow for use of various actual currencies within the system.

The venue function of the software application generally comprises the home page of the user. This allows the user to customize their page to reflect their personality, talent and goals. The user may include images, artwork, and aspirations on their homepage to promote their brand. Users may also arrange content and other offerings on their homepage to attract other users to their site. For example, an artist may customize their homepage to promote specific content available thereon. A manager or venue may also customize their homepage to reflect the type of talent they wish to attract. Fans may customize their homepage to reflect their personality and the types of artists they wish to follow. Content on the user's site may include songs, videos, interviews, stories, press releases, influencers, regions of interest, genre specific information, region specific information, and scores from the brand accelerator. The content information may be referred to as the content stack. The venue may also include a stage allowing the user to provide content which is viewable by visitors to the venue. The stage generally comprises a window within the homepage which displays content selected by the visitors. Visitors may select audio or video files which are played in the stage.

Unlike other online venues, the user may be provided with earning opportunities through product placements, a personal retail store and/or venue activity. Venue activity may include one or more of promotions, giveaways, exclusive content, and display and evaluation of community submitted content. The user may also have the ability to accept and reject content submitted by other users within the system. Accepted content can be arranged within the homepage and be made available for view or download by other users. Users may also offer opportunities for business arrangements within their homepage. For example, an artist may use their homepage to solicit a new user or manager for their musical group.

Customizations for the user's homepage may be menu-driven and applied to the venue via a click and drag mechanism. General customizations may be available for no cost while premium customizations may be available for purchase via credits or monetary transactions. Transactions in the venue may be handled via revenue credits which may be purchased and gifted. Earned revenue credits may be redeemed for cash or used to purchase both virtual and physical goods.

In addition to promoting individuals or groups, users may incorporate advertisements for products or services into their homepage. This provides advertisers with a range of marketing opportunities that significantly increase placements and conversions due to the targeted audiences, contextualization and automation of the interactive and engaged community. Product placements can be made within the user's venue creating a revenue stream for the user. The brand accelerator in conjunction with the social network may also guide product placements and other users to the venue thereby maximizing product placement performance. The product placements may be purchased as virtual goods within the venue. Such product placements may be purchased with credits based on experience or performance within the software application.

The artist may provide sponsored goods and/or content within their venue. A menu of available sponsorships may be available within the platform which would allow the artists to apply for sponsorships and display recommended advertisements within their venue. The sponsorships may provide additional revenue streams for the user.

The venue function may also allow the user to add a personal retail store to their homepage thereby providing an additional revenue stream for the user. Full e-commerce capability for virtual and physical goods may be available for purchase utilizing purchased credits or online monetary transactions such as PayPal. As discussed, credits may be earned, gifted and/or purchased.

Venue design is preferably structured to allow users to differentiate themselves from other users within the system. The venue design also provides for ease of use in exchange of information and communication. It should be amenable to groups as well as individuals with community links to preferred brands. Venue design may be influenced by brand accelerator data which aids in customization of the venue by automatically identifying recommended design layout for optimum venue experience and performance.

The brand accelerator comprises a smart engine which works in conjunction with the social network and venue. The brand accelerator utilizes data provided from influencers of internet communities, which may include news media, social networks, and industry domain experts. Data from influencers of internet communities may be referred to as the media stack. For example, a group of the top influencers in a given genre may be initially input in the system and rotated over time as the analytics change to maintain the top influencers within the genre. The brand accelerator may also utilize user provided web locations which may include Facebook pages, blog sites, Twitter, Pinterest, websites, YouTube channels and various web applications. The information from user provided web locations may be referred to as the user stack. Utilizing the media stack and the user stack, the brand accelerator learns about the users and their fan base during use of the application. It provides assistance to users by visualizing and communicating patterns of interest occurring in a user's talent category. The brand accelerator may also learn to promote and protect the user thereby requiring less effort from the user to promote their talents within and beyond the application. The brand accelerator may produce an output to the social network or user specified web locations to achieve a desired result. For example, media publicists may receive various outputs from the brand accelerator resulting in promotion of a user's activities.

The brand accelerator may include various functionalities such as ability to learn about the artist and the fan base, auto-contextualization of the user's fan base and artist engagement, auto-stimulation of community activity with the artists social network venue, and automated posts and messaging. Security controls may also be included within the brand accelerator which allow the artist to set parameters that determine the range and scope of community interactivity and account visibility. Profile controls within the brand accelerator may allow the user to create an open-market talent image (i.e. brand) and engage the social network as an accelerator and protector of that open-market talent brand.

The brand accelerator may process data via an application routine. The application routine analyzes subscriber and fan base activity within the social network. As previously discussed, this data may be referred to as the media stack or the user stack. Such information may be provided to the brand accelerator from a data analyzer. The data analyzer may comprise one or more components which calculate one or more values indicative of media influence, virality, market cap and/or new releases. For example, the data analyzer may calculate one or more values including a media influence value, a virality value, a market cap value and a new releases value.

The media influence generally comprises a quantitative value which represents the ability of the user to influence the media. This value may be a percentage or value calculated within the system. For example, the media influence value may be a value representing the average impressions per campaign (i.e. viewers associated with a particular publishing location).

The virality value generally comprises a quantitative value which represents the extent to which a user's content has gone viral within the online environment (i.e. internet). This value may be a percentage or value calculated within the system. The virality value may be monitored over time and utilized as a predictive indicator of the possibility of a user's content going viral. This predictive indicator may be useful in promoting the user to a venue or label. The virality value may be calculated by tracking the number of times content is shared and subsequently forwarded to obtain a value indicative of the virality of the shared content. This may be continually calculated during the user's involvement in the system or calculated over a given time period.

The market cap value generally comprises a quantitative value which represents the sales of a user's content and the size of the user's fan base within the system. This value may be a percentage or value calculated within the system. The market cap value may be calculated by performing a calculation based on the total fan base and sales of the user. For example, the market cap value may be calculated by multiplying the total amount of a user's sales by the overall percentage of fans within the system that are fans of the user. This number may also be a percentage indicative of the percentile ranking of users within the system in relation to the metrics of overall sales and fan base.

The new releases value generally comprises a quantitative value which represents the rate of new content uploaded to the system or a user's homepage by a user or fan base of the user. This value is indicative of the activity of a user and their fan base. For example, the new release value may count the content presented by fans and/or users which becomes official content of a user's portfolio as provided on the user's homepage. This value may be calculated and monitored over a given time to understand the activity of a user. For example, this value may be calculated for a 1 week period, a 1 month period, a one year period or the overall period of involvement of the user in the system.

Upon receipt of data from the data analyzer regarding a particular user, the brand accelerator proceeds to determine the next best actions for the user and begins to populate the artist development plan for the user. The next best actions are determined by performing calculations within the brand accelerator with respect to marketability, connections and offers and incentives. Marketability may be represented by a quantitative value indicative of one or more of the user's virality, media influence, market cap and new release rate. Connections may be a quantitative value indicative of one or more of the number of fans for the user, venues played per region, times of playing certain venues, rates of sell-outs at venues, and post show virality. Offers and incentives may be represented by a quantitative value indicative of one or more of the type of offers or incentives provided by the user, rates of offers or incentives provided by the user, number of offers or incentives used by recipients, and offers or incentives accepted and used by recipients.

The data results from the brand accelerator may be communicated to the users via scores, rankings and/or graphics. This will allow users to review and monitor trends over a given time period. The data processed by the brand accelerator may be stored in a database. The database may have a storage capacity enabling data over a selected period (e.g. 18 months) to be stored and available for later use. An analytics routine within the brand accelerator module may assess and track the stored data to provide automated brand protection and promotion activity within the bounds of intent as established by user's profile. A write routine within the social network brand accelerator module may execute on the analytics and profile brand decision data to write or post content various web locations on behalf of the user.

Results will also include one or more next best actions for the user to take to further grow and improve their brand. Next best actions may be selected for the user based on the data results calculated in the brand accelerator. The next best actions include recommended actions for the user to take to further grow their brand and connectivity within the system. Examples of next best actions may include recommendations relating to development of new content, providing offers or incentives to a user's fan base, creation of posts on a user's website or Facebook page, communicating with a venue or manager, contests for the user to enter, content to acquire or develop, contacts to make, locations or new markets to expand into, community engagement, sponsors to pursue, and genres to consider.

An opt-in function may be available which will require the user “opt-in” to use the brand accelerator capability. The personal user and fan base data may not be used in the brand accelerator to protect the privacy of the user. To avoid personal representation or use of personalized data, a user may operate within the system by utilizing an avatar or alias.

The customization portal will allow the social network and venue to be customized with skins, product placements, advertisements and various kinds of virtual goods. The customization portal may reflect various items by category for adoption with differentiated representation in display for customizations 1) that are free, 2) that are recommended by brand accelerator data, and 3) that are premium and available for purchase. The premium content available for purchase may be available for purchase via premium site licensing and/or use of revenue credits earned or purchased within the system. The customization portal may include a web extension of the social network providing a commerce portal for acquisition and/or purchase of virtual goods, sponsorships and/or services. Customizations may be menu-driven and applied to venue via select and place mechanisms. Product placements categories may be made available within the customization portal. Only the product placements that fit the advertiser's selection criteria and that the brand accelerator data determines as “qualified” should be presented in display.

A personal retail store category may be made available within the customization portal for use by the users. The user's store may be designed and maintained within the portal by the user. The store may utilize a release mechanism to promote the store to the social network. The users may be able to simultaneously maintain a production version within their venue and a maintenance version within the customization portal. The customization portal and retail store may support full e-commerce capability for virtual and physical goods; commerce capability should be available via credits and/or monetary online transactions.

A sponsorship category may also be made available within the customization portal. The sponsorship category allows the user to sponsor goods and/or services that they wish to support. A menu of available sponsorships may be made available within the customization portal. Based on brand accelerator data and sponsor selection criteria, the user may also have ability to apply for sponsorships available within the customization portal. The support team of the application may also have the ability to authorize or approve user applications for sponsorships.

The system and platform may include a fan generation functionality to assist the user with generation of a fan base. The fan generation functionality utilizes information from the brand accelerator and the data analyzer to assist the user. Upon registration of an artist into the system, the information from the artist is stored into an artist database. Additionally, the system may maintain a database of influencers. An influencer may be an entity which provides influence to an artist. Influencers may include users in the system such as managers, venues and fans. Influencers may also include individuals or entities outside of the system. Influencers outside of the system may include publicists, publishers, authors, and columnists which receive communications from the system regarding content and artists within the system. The user database and influencer database may be continually updated with scores and other data from the brand.

Upon registration, the user begins working on a development plan based on designation within the system as an artist or influencer. Based on the development plan, the user may begin updating their venue with content to build their content stack. The content stack may include songs, videos, interviews, stories, press releases, influencers, regions of interest, genre specific information, region specific information, and scores from the brand accelerator. The content may be uploaded to the venue by the user or other users in the system. Content uploaded to a user's homepage or venue by other users may require screening by the user prior to the content being allowed.

The content included in the user's content stack may be shared to news wires or the media stack by a content delivery network. The content delivery network may automatically generate and send various types of content and/or communication to the media stack and news wires as determined by the user. The user may also manually send content and/or communication to news wires and the media stack as they determine. Upon receipt of the content and/or communications by the media stack, users and entities within the media stack will have an opportunity to react to the received content and/or communications by taking various actions within the web community. For example, the media stack may elect to take various actions such as “Tweet it”, “Like it”, “Pin it”, “Share it”. Such functions may be included on social media resources such as Facebook, Twitter, and Pinterest. Additionally the media stack may forward the content and/or communication, prepare comments or write columns, stories, and blogs regarding the content and/or communications. Once the media stack has reacted to the content and/or communications from the content delivery network and provided feedback, the feedback is provided to the user's venue (homepage) and used to update the user's user stack. As previously described, a user's user stack may include user provided web locations such as Facebook pages, blog sites, Twitter, Pinterest, websites, YouTube channels and various web applications.

Information from the user's digital venue may also be shared with the fans and used to update the fan database. Such information may be used to provide offers and incentives to fans in relation to content provided by the user.

Information from the media stack and the user stack is then shared with the data analyzer to calculate values such as the media influence value, the virality value, the market cap value, and the new release value. Such values are then shared with the brand accelerator to provide next best actions to the user along with various scores and connections and suggested offers as previously described.

The fan generation continuously performs iterative loops to provide constant feedback to users from the brand accelerator as they progress through the system. By performing the iterative loops, the fan generator may provide direction to the user via the brand accelerator to allow the user to work toward improving their brand or presence within the system.

The software application and platform may include an artist development functionality which utilizes one or more of the social network, venue, brand accelerator and the customization portal. The artist development functionality may include a gameplay feature which includes various levels which are obtained by the artists once certain criteria are met as the artists progress through the software application. The criteria may include various performance characteristics, goals and achievements. Examples of criteria may include number of fans on the social network, performances at certain venues, size of crowds at live performances, achieving certain earning levels based on measureable revenue inside the software application or market cap values, approvals from the support team of the application, and approvals from talent managers, producers, and promoters within the application. Additionally, criteria for determining levels of users may include information from influencers outside the system as determined by the application support team.

As users interact and provide content within the system, different levels may be obtained based on the above mentioned criteria. Based on the level of the user, different opportunities may be made available to the users to support and promote the user's talents. Such opportunities may include earning and performance opportunities. Earning opportunities may include sponsorships, opportunities for advertising, identity and branding coaches, and other earning opportunities. Performance opportunities may include access to talent managers, song writing services, vocal coaches, producers, promoters, access to certain venues, and access to production studios. Such earning and performance opportunities may be referred to as the support stack within the artist development functionality.

Opportunities within the support stack may be provided to the user via the user's venue or homepage as the user reaches various goals and milestones as established within the system. Opportunities may be provided in the form of messages, links, or other types of communications within the system. Once offered to the user, the user may elect such opportunities as they desire while interacting in the system. As the user progresses through the system additional opportunities will continue to be presented based on the status of the user.

In addition to being provided opportunities based on the level of the user, users may obtain in-game credits based on performing certain activities. Such credits may be redeemed for opportunities as described above as set forth in the system. Additionally, the credits may be used to purchase system resources, additional functionalities, support services and items through the customization portal.

The game engine receives input from the data analyzer and the brand accelerator to continuously monitor the status and progress of the user. The various levels achievable and credits earned within the game engine may be based on one or more elements selected from media influence value, virality value, market cap value, new release value, next best actions, offers and incentives, connections, marketability score, size of fan base, input from application support team, input from designated managers, input from designated venues, and input from influencers.

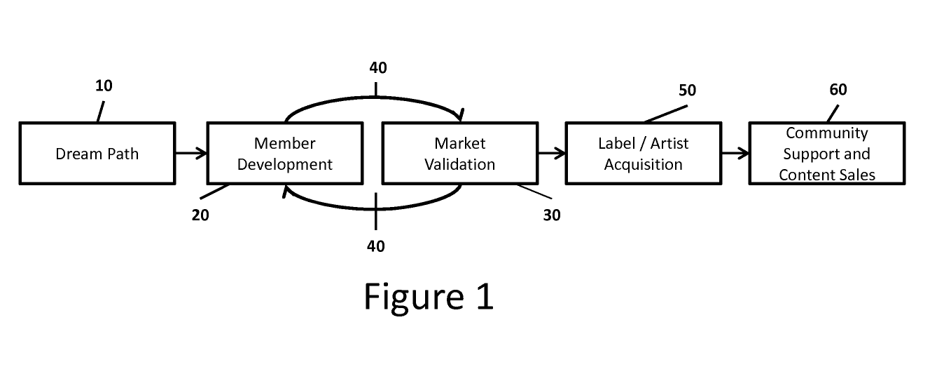

As shown in FIG. 1, the game engine includes a dream path module 10, a user development module 20, a market validation module 30, a label/artist acquisition module 50, and a community support and content sales module 60.

At registration for the game functionality, users (artists, managers, venues and fans) walk thru an intelligent dream path development plan within the dream path module 10. This is a process by which the brand accelerator is contextualized for the user in terms of identity and goals. The dream path output of the dream path module then operates as the user development plan which is a living plan that drives in-context navigation for breaking through barriers and achieving user goals. The dream path module works in tandem with the brand accelerator, whereas the brand accelerator handles next nest action processing and the dream path is the user interface for taking next best actions.

In the user development module 20, users may participate in contests and participate with exchange services to increase their marketability score. The marketability score may be a proprietary value assigned to a user for ranking purposes. The brand accelerator generates the score weekly; the higher a user is ranked within their community, the more attractive the user will be to acquirer's as well as ability to drive influence across the system with acquirer's. User development is a series of next best actions taken by the user; these actions are drawn from a proprietary database derived from 40+ years of insider experience developing, promoting and supporting artists and others navigating the complex entertainment industry.

In the market validation module 30, users gain validation as a function of increased marketability scoring. Validation may be measured in terms of awarded votes in contests and other events, as well as a function of fan acquisition and sales rates and other like activities.

In the Development/Validation Cycle 40, a user cycles through the user development module 20 and the market validation module 30 in support of reaching their goal(s). The brand accelerator in conjunction with the dream path work together to drive the next best actions to the user and measure the validation level for each action. A user's rate of interaction and attention to recommended next best actions influences up or down users potential with the acquisition stage 50.

In the label/artist acquisition module 50, labels and artist promotion agencies will have access to users via the search functionality. The search functionality provides fans, artists, venues, managers and others quick and structured access to content, people and opportunities; specifically to label acquisition. Labels will have ability to view scorecards and take actions within the scope of the label stack.

In the community support and content sales module, artists will have the ability to interact with their fan base and gain support in the community. Additionally, artists will have the ability to sell and share content with the fan base and community.

The label acquisition functionality of the system may include a search function which provides users with the ability to perform searches of other users in the system. Users may be able to perform searches from their homepage. This will allow users (artists, manager, venues, and fans) to search for one another based on a number of available search criteria. Based on the objective of the user, the overall experience and available tools and options for searching may vary case to case. All of the users, whether artist, manager, venue or fans, are linked together and capable of interacting with one another within the system. The search function may perform searches of data generated by the brand accelerator and/or the data analyzer. Search criteria may include media influence value, virality value, market cap value, new release value, next best actions, offers and incentives value, connections value, marketability score, size of fan base, content viewed, content purchased, genre, venues played, influencers, content shared, type of comments, rate of comments, keywords, votes, site visits, and rate of abandonment (fans abandoning the site).

Users will be able to perform a search utilizing the above criteria to obtain a list of artists, managers or venues pursuant to their search criteria. The lists may be ranked based on areas of importance entered by the user. The lists may also be ranked based on a composite score calculated by the brand accelerator. Areas that may be scored are fan count, revenues, trends, readiness, and goals. A fan count score may be a numerical value reflecting the number of fans currently following a user. A revenue score may be a numerical value reflecting the amount of revenue a user has generated over a period of time. A trend score, may be a numerical value representing one or more trends regarding activities of the user such as new content released, views, content shared, content downloaded, and venues played. A readiness score may be a numerical value reflecting the readiness for an artist to proceed within the system. For example, the readiness value may be a numerical indicator of the readiness of an individual to advance to the next level in the gameplay feature. The readiness value may also reflect the readiness of a user to play a given venue or sponsorship level. The goals value may be a value reflecting the extent to which the user's goals within the system have been accomplished. One or more of these values may be included on a scorecard generated by the brand accelerator. The scorecard may be available for review by system users based on searches performed in the system. The scorecard may also be displayed in the user's venue.

Visitors outside the system may also have the ability to perform searches of users within the system. Visitors not registered in the system may only have limited access whereas registered users will have access to all searching functionalities available within the system.

Upon entering the system as an artist, manager, venue, or fan, the user will have to first create a profile. To create a profile, certain information from the user will need to be input into the system. The information necessary to create a profile may include name of participating user, contact information of participating user, assignee, genre, description of user, and user stack information. Steps to validate the information profile may be taken to ensure that the profile of the user is valid. If a user does not wish to create a profile, search options will be available to search various artists, managers, venues, and fans in the system but interaction with other users may not be permitted to users without a valid profile.

After registration as an artist, various functions and/or selections will be available to the user based on the artist classification. The user may review hits on their profile, search profiles of other users on the system, initiate contact with other users, communicate with other users, enter agreements with managers and/or venues, offer content, merchandise and other goods to fans and utilize the functionality of the brand accelerator to promote their content and brand.

After registration as a manager, various functions and/or selections will be available to the user based on the manager classification. The user may search for various artists based on categories such as genre, fan base, ratings, comments, scores from the brand accelerator and goals. The searching may be manual or automatic through utilization of the brand accelerator functionalities. The user may also view artist content, communicate with other users, provide feedback to users, bid on artist representation, purchase and share artist content and validate fans of the artists.

After registration as a venue, various functions and/or selections will be available to the user based on the venue classification. The user may search for various artists based on categories such as genre, fan base, ratings, comments, scores from the brand accelerator and goals. The searching may be manual or automatic through utilization of the brand accelerator functionalities. The user may also view artist content, communicate with other users, provide feedback to users, bid on artist performances and/or content, purchase and share artist content and validate fans of the artists.

After registration as a fan, various functions and/or selections will be available to the user based on the fan classification. The user may search for various artists based on categories such as genre, fan base, ratings, comments, scores from the brand accelerator, and new content. The searching may be manual or automatic through utilization of the brand accelerator functionalities. The user may also view artist content, communicate with other users, provide feedback to users, upload content, and purchase and share artist content.

Users may also register under one or more categories of users within the system (artist, manager, venue, and fan). For example, a user may be registered as both an artist and a fan. In such case the user would have all the functionality of an artist and a fan within the system.

In addition to registering within the system as an artist, manager, venue, or fan, third parties may register with the system as a service provider. Service providers registering with the system may be subject to approval by the application support team. Service providers may also be allowed to advertise or sponsor content within the system. Service providers may include production studios, equipment providers, catering services, transportation providers, legal service providers, accountants, stage crews, costume designers, make-up artists, hairdressers and other individuals offering other support functions to the users, particularly artists. The service providers would have a profile within the system that may be searched by the users based on the types of services being offered. As an alternative to manual searching, various service providers may be recommended to artists utilizing the brand accelerator functionality. For instance, next best actions as provided by the brand accelerator may recommend a user to contact certain service providers. In such case various service providers may be referred to users in an automatic fashion based on determination of the brand accelerator. Service providers may be available to the users via the user's venue, the customization portal and the support stack within the artist development functionality.

While there have been described what are believed to be the preferred embodiments of the present invention, those skilled in the art will recognize that other and further changes and modifications may be made thereto without departing from the spirit of the invention, and it is intended to claim all such changes and modifications as fall within the true scope of the invention.

1. A system for promoting talents of a user comprising:
a social network allowing the user to interact with a community of users within the system;
a venue comprising a homepage, said venue allowing the user to upload content and information to said homepage for review and download by said community of users within the system; and
a brand accelerator, wherein said brand accelerator provides the user with a set of one or more next best actions for promoting the user within said system, said set of next best actions based on information received by said brand accelerator from said social network.

2. The system in accordance with claim 1, wherein said social network populates one or more social networks external to said system with a feed of content provided by said user.

3. The system in accordance with claim 1, wherein said brand accelerator utilizes information from a media stack to provide said set of next best actions to said user.

4. The system in accordance with claim 1, wherein said brand accelerator utilizes information from a user stack to provide next best actions to said user.

5. The system in accordance with claim 1, wherein said brand accelerator provides outputs to a set of one or more influencers to promote the user.

6. The system in accordance with claim 1, wherein the brand accelerator receives one or more values from a data analyzer, said one more values being utilized by said brand accelerator to generate a set of next best actions to be provided to the user.

7. The system in accordance with claim 6, wherein said data analyzer generates one or more values selected from a media influence value, a virality value, a market cap value and a new releases value.

8. The system in accordance with claim 6, wherein said brand accelerator generates said set of next best actions based on calculations with respect to one or more values selected from a marketability value, a connections value and a offers and incentives value, whereby said marketability value, said connections value and said offers and incentives value are calculated by said brand accelerator.

9. The system in accordance with claim 8, wherein said marketability value, said connections value, said offer and incentives value and said set of next best actions are communicated to the user via a ranking, a scorecard, or a graphical representation.

10. The system in accordance with claim 1 further comprising a gameplay feature, whereby said gameplay feature includes a plurality of levels attainable by the users, each of said plurality of levels requiring completion of a set of criteria by the user, each of said levels obtained by the user providing different opportunities for the user.

11. The system in accordance with claim 1, wherein said system includes a search functionality whereby users of the system may search for other users based on a series of search criteria.

12. The system in accordance with claim 1 further comprising a customization portal, wherein the customization portal provides for customization of said venue by said user.

13. The system in accordance with claim 12, wherein said customization portal includes a sponsorship category which allows users to apply for sponsorships within the system.

14. The system in accordance with claim 1, wherein a set of service providers are provided to users as a resource within the system.
